(19) United States
(12) Patent Application Publication
(10) Pub. No.: US 2020/0127694 A1
(43) Pub. Date: Apr. 23, 2020

(54) MOVABLE ATTACHMENT APPARATUS FOR HOLDING A PORTABLE ELECTRONIC DEVICE

(71) Applicant: ESI Cases & Accessories, New York, NY (US)

(72) Inventor: Kwangpyo Lim, New York, NY (US)

(21) Appl. No.: 16/193,096

(22) Filed: Nov. 16, 2018

Related U.S. Application Data
(63) Continuation-in-part of application No. 29/667,611, filed on Oct. 23, 2018, now Pat. No. D871389.
Application No. 29/667,611 is a continuation-in-part of application No. 29/668,706, filed on Nov. 1, 2018.

(51) Int. Cl. H04B 1/3877; A45C 11/00

(52) U.S. Cl. CPC H04B 1/3877; A45C 2200/15; A45C 2011/002; A45C 11/00

(57) ABSTRACT

A movable attachment apparatus having an elongate body, a first attachment portion coupled on a first end to the elongate body via a rotatable element, and a second attachment portion coupled on a second end to the elongate body, the first attachment portion being attachable to a back surface of a portable electronic device at a first location, the second attachment portion being attachable to the back surface of the portable electronic device at a second location that is different from the first location, and the elongate body being rotatable around the rotatable element when the first attachment portion is attached to the back surface of the portable electronic device and the second attachment portion is detached from the back surface of the portable electronic device.

### CROSS-REFERENCE TO RELATED APPLICATION

The present application is a continuation-in-part of U.S. patent application Ser. No. 29/667,611, filed Oct. 23, 2018, and U.S. patent application Ser. No. 29/668,706, filed Nov. 1, 2018, the entire contents of each of which are incorporated by reference herein,

### FIELD OF THE INVENTION

The present invention relates to an attachment apparatus for holding a portable electronic device, such as a mobile telephone, that is movable so as to facilitate wireless charging of the portable electronic device.

### BACKGROUND OF THE INVENTION

With the proliferation of portable electronic devices having large displays that substantially cover a front side of such devices—for example, cellular telephones such as the Apple iPhone, Samsung Galaxy, and the like—a need for a convenient means of securing a user's grip on such devices while the user interacts with the front side display became readily apparent. Accordingly, there have been many device holders that have been developed for attaching to portable devices, such as cellular phones.

More recently, the means of recharging such portable devices have undergone significant advancements. As an example, such devices now incorporate electromagnetic circuitry (for example, a planar coil) configured to recharge their batteries wirelessly by being placed proximate a corresponding charging pad (with a corresponding planar coil) that emits near-field electromagnetic signals to induce the wireless-charging circuitry of the portable devices upon detecting the portable devices. One known example of this technique is the so-called “Qi” standard for wirelessly charging portable electronic devices.

### SUMMARY OF THE INVENTION

In most portable devices, the wireless charging circuitry is disposed near a back portion of the device so that it can be placed on top of a charging pad for convenient charging. Operationally, the circuitry (e.g., planar coil) on the back portion of the portable device substantially aligns with the circuitry (e.g., planar coil) in the charging pad for wireless induction. However, most popular device holders are also disposed on a back surface of the portable devices. For example, most ringholders and PopSockets®-type holders are semi-permanently affixed to the backs of the cellular telephones, by, for example, a one-time “peel and stick” adhesive. Thus, when such a holder has been affixed to the back surface of a cellular telephone, wireless charging cannot be performed because the holder obstructs the wireless circuitry of the cellular telephone from properly aligning with the charging circuitry of the charging pad when the cellular telephone is placed on top of the charging pad.

In some cases, the device holders (e.g., ringholders, PopSockets®, and the like) are attached to a protective case from which the portable device may be removed, thus allowing the portable device to be charged wirelessly when it is removed from the protective case. However, even though the use of protective cases is sufficiently commonplace such that many users would be able to wirelessly charge their devices while still using a device holder, the requirement that the device be removed from the protective case for wireless charging presents such a significant inconvenience that it becomes debatable whether wireless charging in this context is any more convenient than conventional wired charging.

In view of the popularity of device holders such as PopSockets® and the proliferation of wirelessly-chargeable devices, there is a need for a device holder that does not obstruct wireless charging.

In view of the above-identified incompatibility between common device holders and the increasingly popular wireless charging schemes, it is an object of the invention to provide a moveable attachment apparatus that is configured to provide the utility of a conventional device holder while being movable so that the holder can be set aside for wireless charging, and without the need for removing a device from its protective case for such wireless charging,

According to an exemplary embodiment of the invention, a movable attachment apparatus comprises an elongate body, a first attachment portion coupled on a first end to the elongate body via a rotatable element, and a second attachment portion coupled on a second end to the elongate body, the first attachment portion being attachable to a back surface of a portable electronic device at a first location, the second attachment portion being attachable to the back surface of the portable electronic device at a second location that is different from the first location, and the elongate body being rotatable around the rotatable element when the first attachment portion is attached to the hack surface of the portable electronic device and the second attachment portion is detached from the hack surface of the portable electronic device.

According to an exemplary embodiment of the invention, the first attachment portion is attachable semi-permanently to the hack surface of the portable electronic device and the second attachment portion is attachable temporarily to the back surface of the portable electronic device.

According to an exemplary embodiment of the invention, the movable attachment apparatus comprises a holder element coupled at the second end to the elongate body.

According to an exemplary embodiment of the invention, the holder element comprises a rotatable ring element,

According to an exemplary embodiment of the invention, the holder element is detachably coupled at the second end to the elongate body.

According to an exemplary embodiment of the invention, the holder element is coupled at the second end to the elongate body by an adhesive.

According to an exemplary embodiment of the invention, the first attachment portion comprises an adhesive and the second attachment portion comprises one or more suction cups.

According to an exemplary embodiment of the invention, the first attachment portion comprises an adhesive and the second attachment portion comprises a magnetic element.

According to an exemplary embodiment of the invention, an additional magnetic element is adhered to the back surface of the electronic portable device for attachment with the magnetic element of the second attachment portion.

According to an exemplary embodiment of the invention, the back surface of the portable electronic device to which the first attachment portion is attached forms a portion of a detachable protective cover for the portable electronic device.

According to an exemplary embodiment of the invention, a movable attachment apparatus comprises a flexible elongate body, a first attachment portion coupled on a first end to the flexible elongate body, and a second attachment portion coupled on a second end to the flexible elongate body, the first attachment portion being attachable to a back surface of a portable electronic device at a first location, and the second attachment portion being attachable temporarily to the back surface of the portable electronic device at a second location that is different from the first location.

Other features and advantages of the present invention will become readily apparent from the following detailed description and the accompanying drawings.

### BRIEF DESCRIPTION OF THE DRAWINGS

FIG. 1 is a front view of a movable attachment apparatus in accordance with an exemplary embodiment of the invention.

FIG. 2A is a perspective view of a movable attachment apparatus attached to a portable electronic device in accordance with an exemplary embodiment of the invention.

FIG. 2B is a back view of a movable attachment apparatus attached to a portable electronic device corresponding to the perspective view illustration of FIG. 2A.

FIG. 2C is a perspective view illustrating a movable attachment apparatus with a ring element rotated outward around a post element in order to function as a stand for a portable electronic device in accordance with an exemplary embodiment of the invention.

FIG. 3A is a perspective view of the movable attachment apparatus of FIGS. 2A and 2B having been rotated ninety (90) degrees around a bearing element according to an exemplary embodiment of the invention.

FIGS. 3B and 3C are diagrams illustrating a portable electronic device being placed on a wireless charging pad and a wireless charging stand, respectively, with the movable attachment apparatus rotated around a bearing element in correspondence with the configuration shown in FIG. 3A.

FIGS. 4A and 4B illustrate a movable attachment apparatus in accordance with another exemplary embodiment of the invention.

FIGS. 5A, 5B, and 5C illustrate a movable attachment apparatus in accordance with yet another exemplary embodiment of the invention.

FIG. 6 is a diagram with a close-up section illustrating a movable attachment apparatus with an alternative body arrangement in accordance with another exemplary embodiment of the invention.

FIG. 7 is a diagram showing a relevant section of a movable attachment apparatus and an alternative temporary attachment mechanism according to another exemplary embodiment of the invention.

FIGS. 8A and 8B are perspective views corresponding to FIGS. 2A and 3A, respectively, of a movable attachment apparatus having a hinge element and attached to a portable electronic device in accordance with another exemplary embodiment of the invention.

The above and related objects, features and advantages of the present invention will be more fully understood by reference to the following, detailed description of the preferred, albeit illustrative, embodiment of the present invention when taken in conjunction with the accompanying figures, wherein:

### DETAILED DESCRIPTION

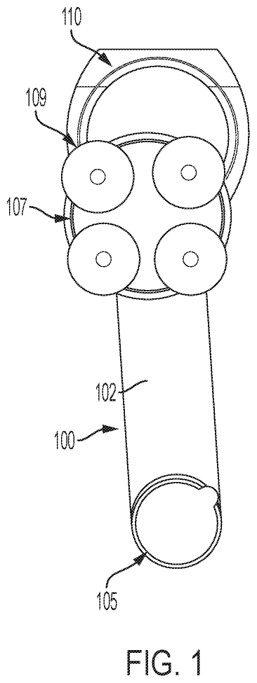

FIG. 1 is a front view of a movable attachment apparatus 100 in accordance with an exemplary embodiment of the invention. As shown in FIG. 1, movable attachment apparatus may comprise an elongate body 102 with a semi-permanent attachment portion 105 on one end of the elongate body 102 and a temporary attachment portion 107 on an opposite end of the elongate body 102. In accordance with an exemplary embodiment of the invention, semi-permanent attachment portion 105 may comprise an adhesive patch, such as a peel-off or “peel and stick” adhesive patch, and the like. Attachment portion 105 may be substantially circular in correspondence with a bearing element, which will be described in further detail below, to form a rotatable attachment point for the attachment apparatus 100 while it is semi-permanently attached to a portable electronic device. As further illustrated in FIG. 1, attachment apparatus 100 may comprise one or more suction cups 109 to form the temporary attachment portion 107. According to an exemplary embodiment, temporary attachment portion 107 comprises four (4) suction cups in a 2-by-2 array to provide sufficient attachment strength while allowing for convenient detachment by a user, as will be described in further detail below. Additionally, attachment apparatus 100 may further comprise a portable device holder element 110, which may be a ring-shaped holder, and the like. Accordingly, as will be described in further detail below, portable device holder element 110 is configured so that a user may hold a portable device using element 110 in a similar manner to conventional device holders, such as PopSockets® and the like. In addition, the semi-permanent attachment portion 105, again, is incorporated with a bearing element that allows for a rotation of the attachment apparatus 100 while the temporary attachment portion 107 is detached from the portable device. As will be described in further detail below, this rotation of the attachment apparatus 100 allows the holder element 110 to be moved away from the wireless charging circuitry of the portable device and to provide for wireless charging.

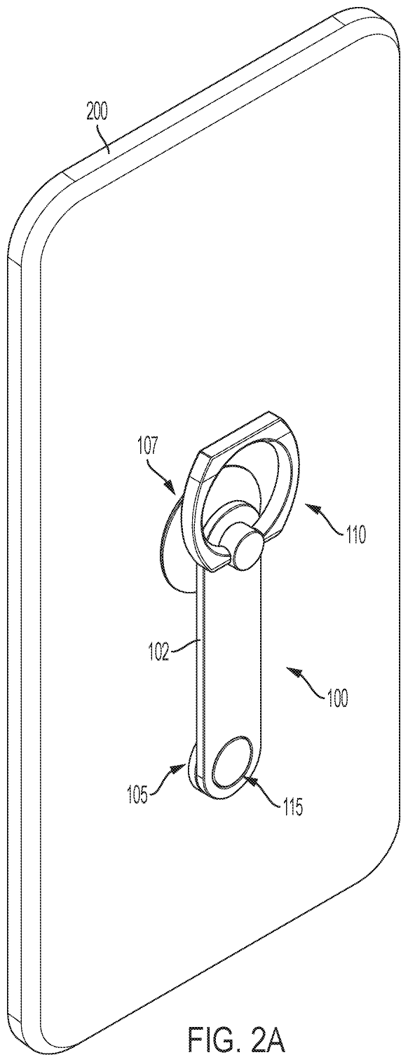

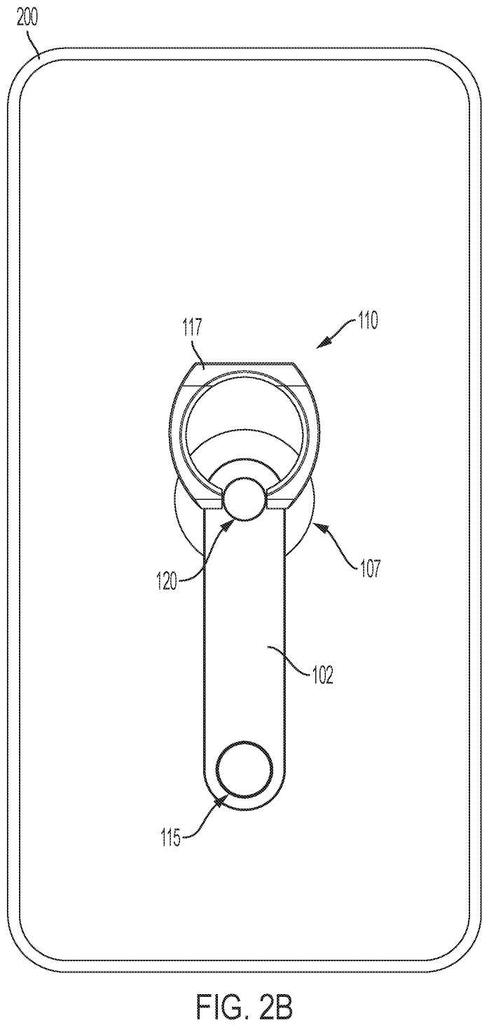

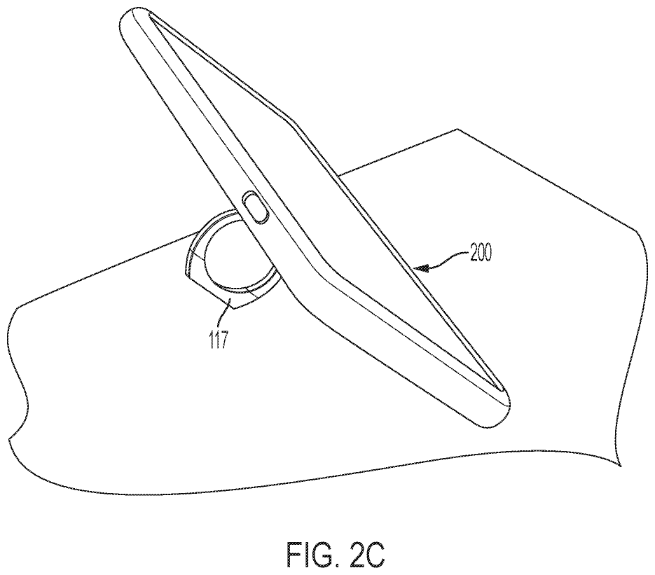

FIG. 2A is a perspective view of movable attachment apparatus 100 attached to a portable electronic device 200 in accordance with an exemplary embodiment of the invention. As shown in FIG. 2A, the movable attachment apparatus 100 may be attached directly to the portable electronic device 200 or to a protective cover on a back portion of the portable electronic device 200 that is on an opposite side to a viewing screen of the portable electronic device 200. According to an exemplary embodiment of the invention, semi-permanent attachment portion 105 may comprise an adhesive patch—such as a peel-off or “peel and stick” adhesive patch, and the like—to semi-permanently attach apparatus 100 to portable electronic device 200 (or its protective cover). According to an exemplary embodiment of the invention, a user may adhere attachment portion 105 at a location that is substantially at a center line between the two side edges across a width of portable electronic device 200 and that is between approximately ⅛ of a length (between the top edge and the bottom edge of portable electronic device 200) from the bottom edge of portable electronic device 200 and the center point of the back surface/protective cover of the portable device 200. In accordance with an alternative embodiment of the invention, attachment apparatus 100 may be integrated with a removable or permanent outer shell, protective cover, housing, etc., of portable electronic device 200 at the aforementioned semi-permanent attachment location to form an anchor point, or fulcrum, for rotating attachment apparatus 100 while it is attached to the portable electronic device 200 (or its protective cover)

As shown in FIG. 2A, attachment portion 105 is coupled to elongate body 102 of attachment apparatus 100 by a joint that comprises a bearing element 115. Bearing element 115 may, thus, provide for the rotation of elongate body 102 around attachment portion 105. According to an exemplary embodiment of the invention, bearing element 115 allows for a full rotation—i.e., 360 degrees—of attachment apparatus 100 while the temporary attachment portion 107 is detached from the portable electronic device 200. As will be appreciated by one of ordinary skill in the art, bearing element 115 may be replaced with any kind of rotatable joint to facilitate the rotation of elongate body 102 around attachment portion 105 without departing from the scope of the invention.

Once attachment apparatus 100 is attached to portable electronic device 200 at attachment portion 105 on a semi-permanent basis, elongate body 102 can be rotated around bearing element 115. Accordingly, as illustrated in FIG. 2A, attachment apparatus 100 may be rotated to an upright position so that temporary attachment portion 107 can be temporarily attached to the back surface/protective cover of portable electronic device 200 at a location between approximately the center point of the back surface/protective cover of the portable device 200 and approximately ⅛ of a length (between the top edge and the bottom edge of portable electronic device 200) from the top edge of portable electronic device 200 substantially at the center line between the two side edges across the width of portable electronic device 200. Once temporary attachment portion 107 is rotated to a desired location, a user may simply press down on the end portion of attachment apparatus 100 in order to engage the one or more suction cups (e.g., four (4) shown in FIG. 1) and temporarily attach the temporary attachment portion 107 and, correspondingly, holder element 110 can be located at a similar position as conventional device holders when it is temporarily attached. As will be appreciated by one of ordinary skill in the art, the one or more suction cups of temporary attachment portion 107 may be replaced with any kind of temporary attachment means—for example, a magnetic element paired with another magnetic element semi-permanently attached to portable electronic device 200—to facilitate the temporary attachment to the portable electronic device 200.

As described above with reference to FIG. 1, temporary attachment portion 107 may comprise four arrayed suction cups that are configured to temporarily attach to the back surface of the portable electronic device 200 (or its protective cover) with sufficient strength for holder element 110 to function as a conventional portable electronic device holder. According to another embodiment of the invention and as illustrated in FIG. 2A, temporary attachment portion 107 may comprise one large suction cup in place of the four smaller arrayed suction cups shown in FIG. 1. In accordance with an exemplary embodiment of the invention, temporary attachment portion 107—for example, four (4) arrayed or one (1) large suction cup—provides a temporary attachment of holder element 110 at a desired location chosen by a user, as described above, with sufficient strength so that the user may hold the portable device 200 using holder element 110 in a manner similar to other portable device holders, such as PopSockets® and the like. At the same time, temporary attachment portion 107 also allows the user to easily detach holder element 110 from the back surface/protective cover of portable device 200—for example, by peeling the suction cup(s) therefrom. Once temporary attachment portion 107 is detached from the back surface/protective cover of portable device 200, attachment apparatus 100 can be rotated around semi-permanent attachment portion 105 through bearing element 115.

FIG. 2B is a back view of movable attachment apparatus 100 attached to portable electronic device 200 corresponding to the perspective view illustration of FIG. 2A. As shown in FIG. 2B, temporary attachment portion 107 may provide a temporary anchor/attachment point for holder element 110 that approximates a location for a conventional portable device holder. As further illustrated in FIG. 2B, holder element 110 may comprise a ring element 117 that is coupled to attachment apparatus 100 through a hinged coupling to a post element 120. According to an exemplary embodiment of the invention, post element 120 may be rotatable around a central axis that is parallel to the axis of rotation of attachment apparatus 100 around bearing element 115. In addition, ring element 117 may be hinged to post element 120 so as to be rotatable from the position shown in FIGS. 2A and 2B to an opposite side of post 120, or any position in between—for example, to a position perpendicular to elongate body 102 as shown in FIG. 2C. Accordingly, ring element 117 may be placed in any position between these two end positions during use—for example, as will be described in further detail below, ring element 117 may be placed in a position that is perpendicular to elongate body 102 to serve as a prop-up stand for portable electronic device 200. According to an exemplary embodiment of the invention, post element 120 is coupled to temporary attachment portion 107 so that it is fixed rotationally when temporary attachment portion 107—for example, suction cups 109—is attached to portable electronic device 200 in the manner described above. Alternatively, post element 120 may be decoupled from temporary attachment portion 107 so that it remains freely rotatable even when temporary attachment portion 107—for example, suction cups 109—is attached to portable electronic device 200 in the manner described above.

Thus, with temporary attachment portion 107 temporarily attached to the hack surface/protective cover of portable electronic device 200, attachment apparatus 100 may function similarly to a conventional device holder, such as PopSockets® and the like. FIGS. 2A and 2B illustrate a particular exemplary embodiment of the invention wherein the holder element 110 incorporates a ring element 117. FIG. 2C is a perspective view illustrating the ring element 117 rotated outward around post element 120 to function as a stand for portable electronic device 200. According to this exemplary embodiment, post element 120 is coupled to the temporary attachment portion 107—i.e., the one (1) or four (4) suction cups 109—so that the rotation of post element 120 is restricted in order to provide ring element 117 with additional stability in holding up portable electronic device 200.

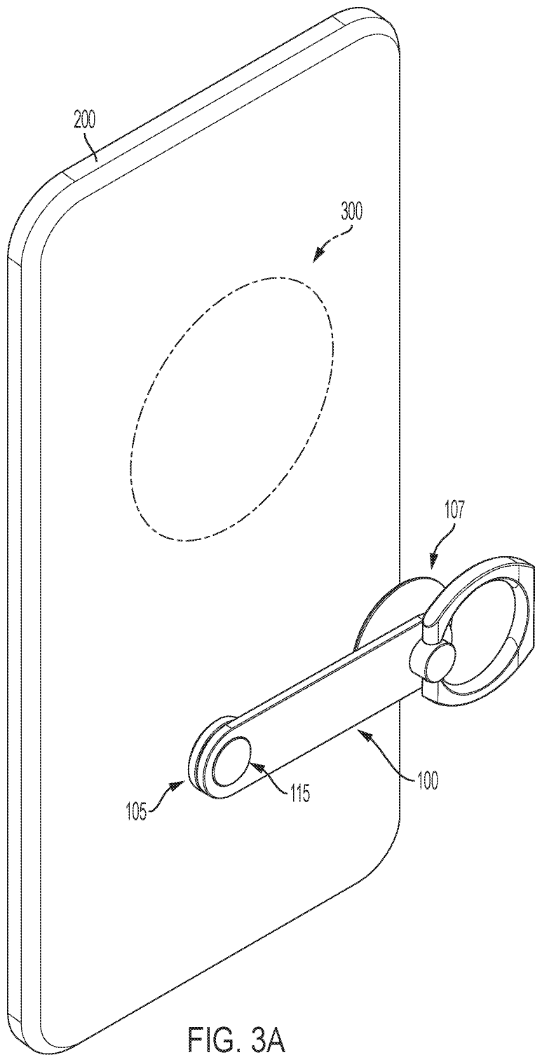

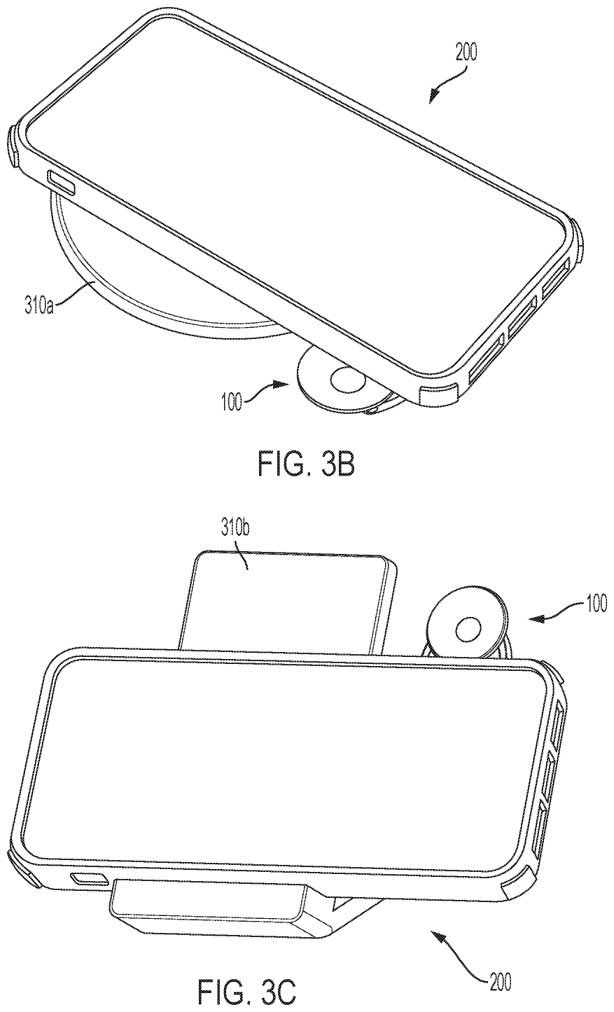

Referring now to FIG. 3A, attachment apparatus 100, again, can be rotated around bearing element 115 while it is semi-permanently attached to portable electronic device 200 at attachment portion 105 and while it is detached from the portable electronic device 200 at the temporary attachment portion 107. FIG. 3A illustrates attachment apparatus 100 having been rotated ninety (90) degrees around bearing element 115 from the configuration shown in FIGS. 2A and 2B according to an exemplary embodiment of the invention. It should be noted that bearing element 115 may be a three hundred and sixty (360) degree rotational bearing element that allows attachment apparatus 100 to be rotated around and back to the original configuration shown in FIGS. 2A and 2B. As shown in FIG. 3A, with attachment apparatus 100 rotated away from the temporary attachment point for attachment portion 107—and correspondingly, holder element 110—an area 300 on the back surface/protective cover of portable electronic device 200 becomes unobstructed even with attachment apparatus 100 still attached thereto. Advantageously, with area 300 exposed, portable electronic device 200 may be placed on a wireless charging pad for wireless charging. As briefly noted above, area 300 on the back surface of portable electronic device 200 shown in FIG. 3A corresponds generally to the location of wireless charging circuitry in portable electronic device 200 for wireless charging. Thus, by placing portable electronic device 200 on a charging pad, with attachment apparatus 100 rotated away from area 300, wireless charging can be effectuated.

FIGS. 3B and 3C are diagrams illustrating portable electronic device 200 being placed on wireless charging pad 310a and stand 310b, respectively, with attachment apparatus 100 rotated away from area 300 on the back surface/protective cover of portable electronic device 200. As shown in FIG. 3B, portable electronic device 200 may be placed flat on top of wireless charging pad 310a with area 300 aligned with charging pad 310a. With attachment apparatus 100 rotated away from area 300, the portion of portable electronic device 200 where semi-permanent attachment portion 105 is attached may be placed beyond the edge of charging pad 310a so that portable electronic device 200 lays flat for wireless charging. Correspondingly, as shown in FIG. 3C, portable electronic device 200 may be placed sideways on an inclined charging stand 310b so that area 300 on the back surface/protective cover thereof is aligned with the wireless charging element of charging stand 310b. In a similar manner, the portion of portable electronic device 200 having the attachment apparatus 100 semi-permanently attached thereto may be placed beyond the edge of charging stand 310b so that the back surface/protective cover of portable electronic device 200 contacts the surface of charging stand 310b at area 300 for effectuating wireless charging.

As described above, portable electronic device 200 may be encased in a detachable protective cover (not shown)—for example, a protective phone case—and movable attachment apparatus 100 may be attached to an outer surface of such a detachable protective cover in the manner described above. In accordance with an alternative embodiment of the invention, attachment apparatus 100 may be integrated with the detachable protective cover at the attachment point corresponding to semi-permanent attachment portion 105 described above. In other words, a nut-and-bolt, embedded bearing, or similar attachment mechanism may be used to integrate movable attachment apparatus 100 with a detachable protective cover for use with portable electronic device 200. Corresponding to the illustrations in FIGS. 3B and 3C, portable electronic device 200 can be placed on a charging pad 310a (FIG. 3B) or a charging stand 310b (FIG. 3C) for wireless charging without having to remove portable electronic device 200 from its detachable protective cover having a movable attachment apparatus 100 attached thereto (or integrated therewith).

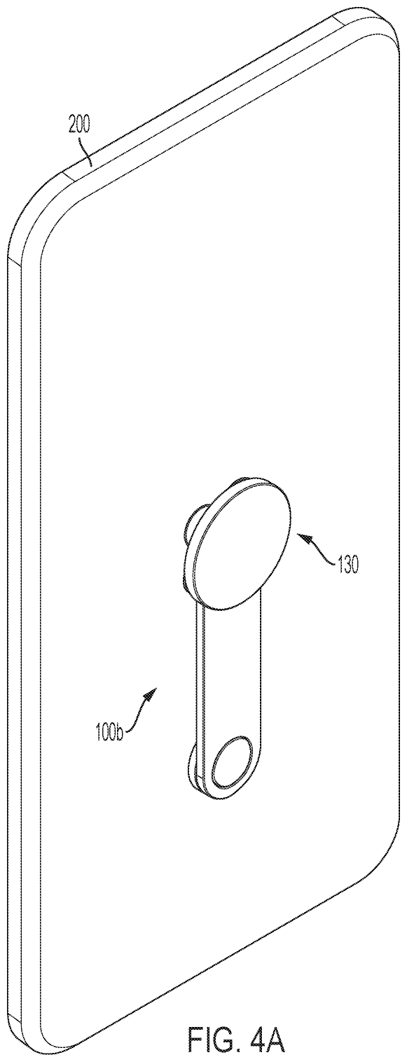

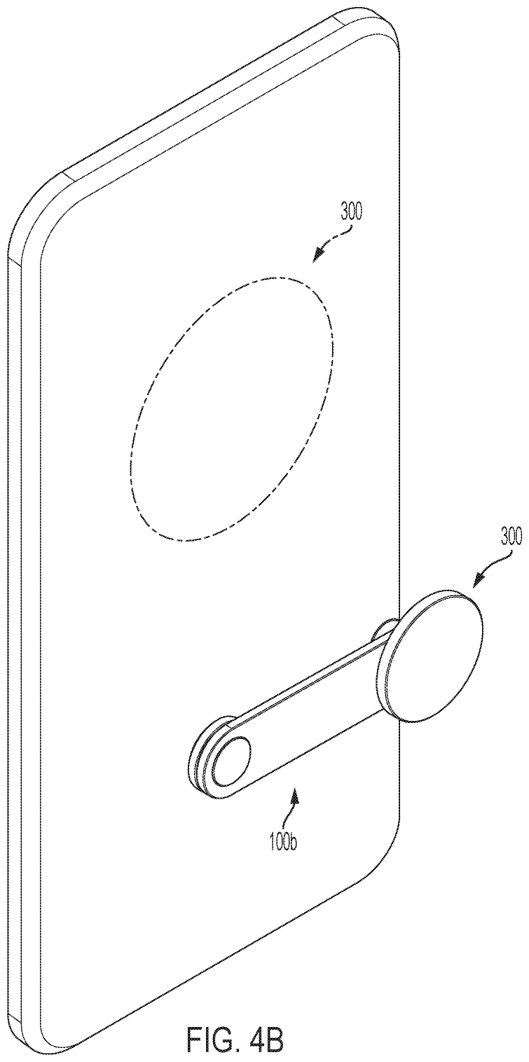

FIGS. 4A and 4B illustrate a movable attachment apparatus 100b in accordance with another exemplary embodiment of the invention. As shown in FIGS. 4A and 4B, movable attachment apparatus 100b comprises a substantially flat platform 130 in place of holder element 110 having ring element 117 and post element 120 (as shown in FIGS. 1 through 3A). According to an exemplary embodiment of the invention, movable attachment apparatus 100b may be provided with a one-time “peel-and-stick” adhesive, and the like, on platform 130 so that an existing portable device holder—such as PopSockets®—that is detached from portable electronic device 200 may be reused by being attached to platform 130. Advantageously, movable attachment apparatus 100b may be used with any conventional portable device holder by semi-permanently attaching such a portable device holder to platform 130. Consequently, movable attachment apparatus 100b provides for the use of any portable device holder without having to sacrifice wireless charging as a convenient feature—either by having to remove portable electronic device 200 from a detachable protective cover for wireless charging or forfeiting wireless charging altogether.

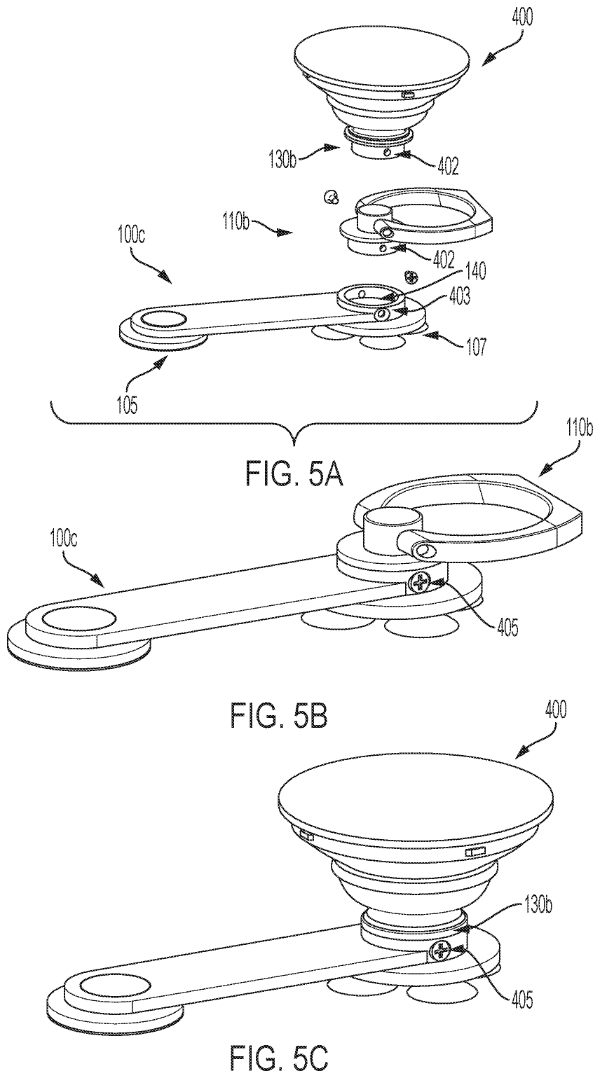

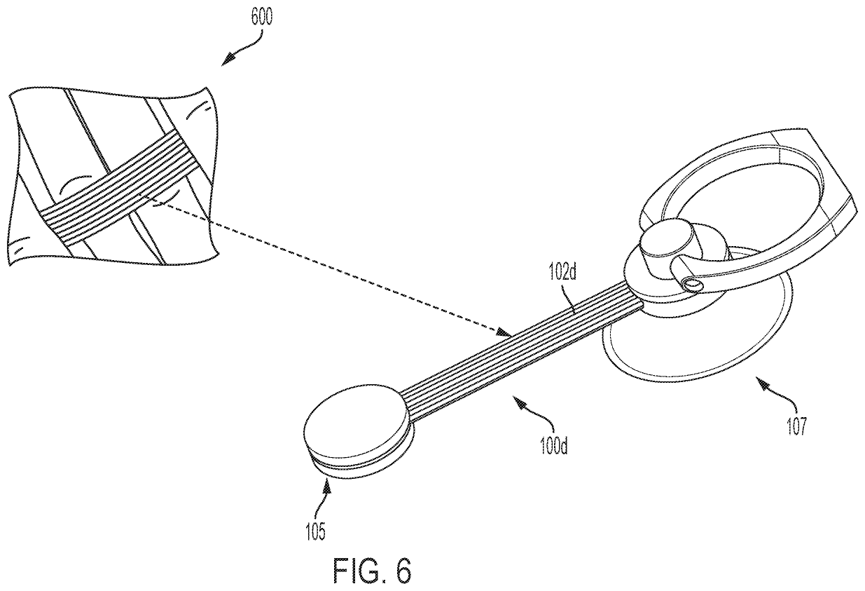

Referring now to FIGS. 5A-C, movable attachment apparatus 100c may be provided with a fitted opening 140 for receiving either a detachable holder element 110b or a detachable platform 130b, each incorporating a fitted protrusion for insertion to fitted opening 140. FIG. 5A is an exploded view illustrating detachable holder element 110b and a PopSockets®-type holder 400 that is semi-permanently attached to platform element 130b as alternatives for coupling to fined opening 140 of movable attachment apparatus 100c. As shown in FIG. 5A, holder element 110b and platform element 130b may each incorporate a recess 402—such as a screw hole, and the like—for receiving a fastening element 405, shown in FIGS. 5B and 5C, in alignment with opening 403 when holder element 110b or platform element 130b is inserted into fitted opening 140.

FIG. 5B illustrates detachable holder element 110b attached to movable attachment apparatus 100c according to an exemplary embodiment of the invention. As shown in FIG. 5B, fastening element 405—such as a set screw, and the like—may be provided through opening 403, shown in FIG. 5A, in movable attachment apparatus 100c for securing holder element 110b. Correspondingly, as shown in FIG. 5C, fastening element 405 may be removed to detach holder element 110b and to replace it with platform element 130b. Similarly, platform element 130b may be secured to attachment apparatus 100c by fastening element 405. In addition, platform element 130b may be provided with, for example, a one-time “peel-and-stick” adhesive, and the like. Thus, a user's existing portable device holder—for example, holder 400 shown in FIGS. 5A and 5C—may be used with movable attachment apparatus 100c while being interchangeable with holder element 110b.

FIG. 6 is a diagram with a close-up section illustrating a movable attachment apparatus 100d in accordance with another exemplary embodiment of the invention. As shown in FIG. 6, movable attachment apparatus 100d may incorporate a flexible and/or resilient body portion 102d in place of elongate body 102 of movable attachment apparatuses 100, 100b, and 100c. Elongate body 102 of apparatuses 100, 100b, and 100c may comprise a polymeric, metallic, or composite material that provides adequate tensile strength and rigidity to elongate body 102 in order to facilitate the above-described semi-permanent attachment, rotation, and temporary attachment of apparatuses 100, 100b, and 100c to portable electronic device 200 or a detachable protective cover thereof instead of rigid elongate body 102, attachment apparatus 100d incorporates a flexible and/or resilient material—such as a woven fabric, elastic material, combinations thereof, and the like—for body portion 102d in order to provide a user with an alternative means for holding portable electronic device 200. As an example, close-up section 600 in FIG. 6 illustrates a user's fingers fitted under body portion 102d so that it provides resilient support to the user's fingers while portable electronic device 200 is being held by the user. According to an exemplary embodiment of the invention, attachment portion 105 may or may not be integrated with a bearing element, such as bearing element 115 illustrated in FIGS. 2A and 3A. While bearing element 115 may provide for rotation of attachment device 100d in a similar manner to attachment devices 100, 100b, and 100c, body portion 102d also provides for moving attachment apparatus 100d away from area 300 for wireless charging such that rotation via bearing element 115 may not be necessary. For example, with temporary attachment portion 107 detached from portable electronic device 200, it may be moved away from area 300 by virtue of the flexibility and/or resiliency of body portion 102d.

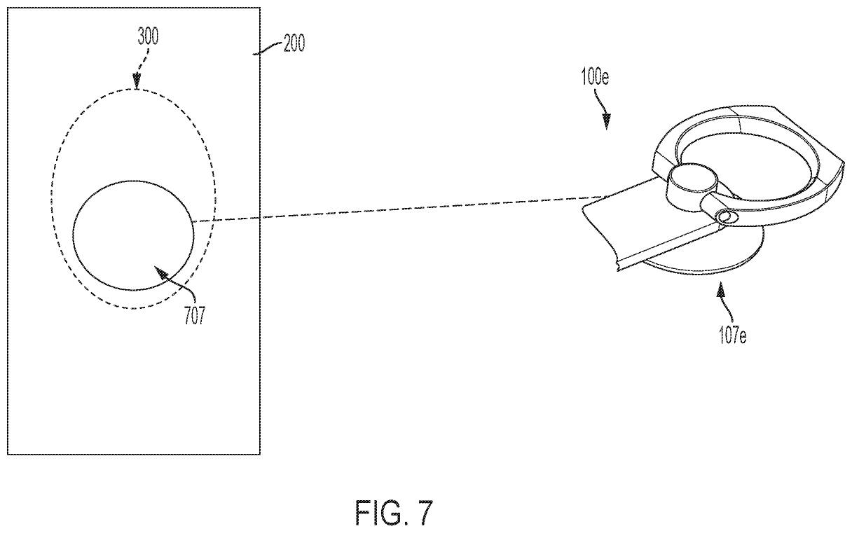

FIG. 7 is a diagram showing a relevant section of a movable attachment apparatus 100e and an alternative temporary attachment mechanism according to another exemplary embodiment of the invention. As shown in FIG. 7, movable attachment apparatus 100e incorporates temporary attachment portion 107e in the form of a magnetic pad. As further illustrated in FIG. 7, a corresponding magnetic pad 707 is adhered to portable electronic device 200—or a detachable protective cover thereof. Thus, instead of incorporating one or more suction cups—for example, four (4) suction cups 109 shown in FIG. 1—movable attachment apparatus 100e temporarily attaches to portable electronic device 200—or a detachable protective cover thereof—by attaching magnetic pad 107e to magnetic pad 707. Magnetic pad 707 is preferably sufficient thin so as not to disrupt wireless charging at area 300 of portable electronic device 200. Correspondingly, magnetic pad 107e may be thicker than magnetic pad 707 in order to supplement the magnetic strength between the pads 107e and 707 when attachment apparatus 100e is temporarily' attached to portable electronic device 200 for use as a portable electronic device holder in the manner described above. Accordingly, movable attachment apparatus 100e may incorporate a semi-permanent attachment portion 105 and bearing element 115 (not shown in FIG. 7) and may operate in a manner similar to movable attachment apparatuses 100, 100b, and 100c described above in rotating away from area 300 to facilitate wireless charging.

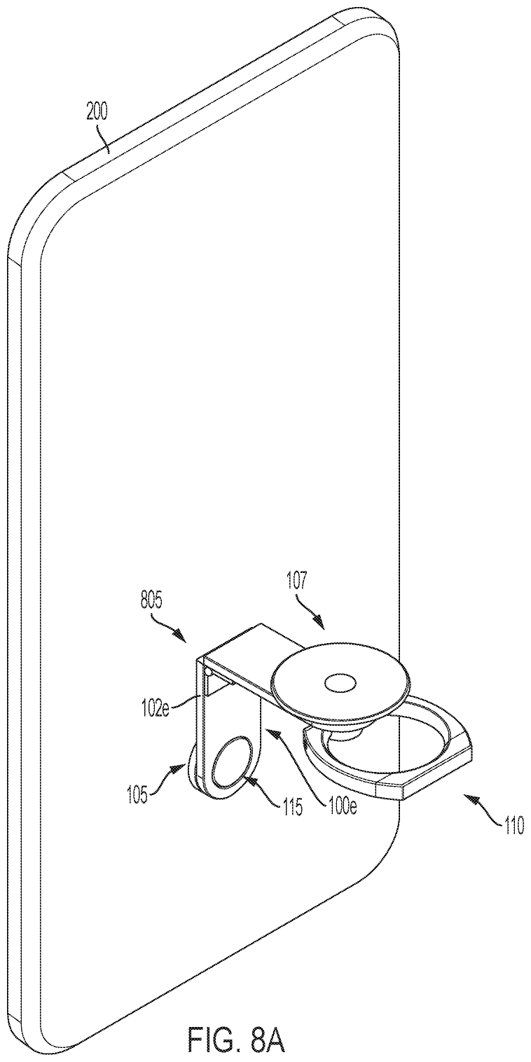

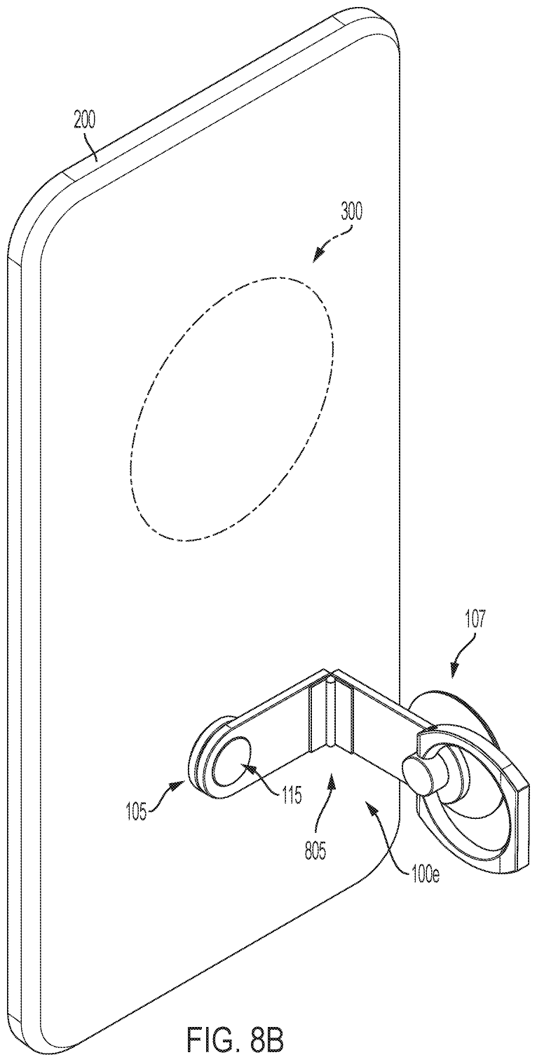

FIGS. 8A and 8B are perspective views of a movable attachment apparatus 100e having a hinge element 805 and attached to a portable electronic device 200 in accordance with another exemplary embodiment of the invention. As shown in FIGS. 8A and 8B, movable attachment apparatus 100e comprises a hinge element 805 on elongate body 102e that allows the end portion of movable attachment apparatus 100e having the temporary attachment portion 107 to pivot upward when a user detaches temporary attachment portion 107 from the back surface of portable electronic device 200 (or its protective cover). Hinge element 805 may comprise one or more of a butt hinge, a flush hinge, a bearing hinge, and the like, to provide the requisite upward pivot described above. Advantageously, the upward pivot provided for by hinge element 805 relieves upward pressure on semi-permanent attachment portion 105 when a user detaches temporary attachment portion 107 from the back surface of portable electronic device 200 (or its protective cover) for rotating movable attachment apparatus 100e away from area 300 to wirelessly charge portable electronic device 200—thereby improving the durability of the adhesion/attachment provided at semi-permanent attachment portion 105 to the back surface of portable electronic device 200 (or its protective cover). According to an exemplary embodiment of the invention, hinge element 805 provides the above-described pivot of the end portion of elongate body 102e up to any angle until it rests upon either a stop in hinge element 805 or an element of the other end portion of elongate body 102e incorporating the semi-permanent attachment portion 105—in other words, any angle below approximately 180 degrees from an original position, as reflected in FIGS. 2A and 3A. Thus, movable attachment apparatus 100e may be rotated away from area 300, as shown in FIG. 8B, to thereby provide for portable electronic device 200 to be placed on an inclined charging stand, such as charging stand 310b illustrated in FIG. 3C. Additionally, movable attachment apparatus 100e (i.e., the end portion of elongate body 102e having temporary attachment portion 107) may be pivoted back down from the position shown in FIG. 8B to a position corresponding to those illustrated in FIGS. 3A and 4B for placing portable electronic device 200 on top of a flat charging pad 310c, as shown in FIG. 3B.

While in the foregoing specification a detailed description of specific embodiments of the invention was set forth, it will be understood that many of the details herein given may be varied considerably by those skilled in the art without departing from the spirit and scope of the invention,

1. A movable attachment apparatus, comprising:
an elongate body;
a first attachment portion coupled on a first end to the elongate body via a rotatable element; and
a second attachment portion coupled on a second end to the elongate body,
wherein the first attachment portion is attachable to a back surface of a portable electronic device at a first location,
wherein the second attachment portion is attachable to the back surface of the portable electronic device at a second location that is different from the first location, and.
wherein the elongate body is rotatable around the rotatable element when the first attachment portion is attached to the back surface of the portable electronic device and the second attachment portion is detached from the back surface of the portable electronic device.

2. The movable attachment apparatus of claim 1, wherein the first attachment portion is attachable semi-permanently to the back surface of the portable electronic device and the second attachment portion is attachable temporarily to the back surface of the portable electronic device.

3. The movable attachment apparatus of claim 1, further comprising a holder element coupled at the second end to the elongate body.

4. The movable attachment apparatus of claim 3, wherein the holder element comprises a rotatable ring element.

5. The movable attachment apparatus of claim 3, wherein the holder element is detachably coupled at the second end to the elongate body.

6. The movable attachment apparatus of claim 3, wherein the holder element is coupled at the second end to the elongate body by an adhesive.

6. The movable attachment apparatus of claim 1, wherein the first attachment portion comprises an adhesive and the second attachment portion comprises one or more suction cups.

7. The movable attachment apparatus of claim 1, wherein the first attachment portion comprises an adhesive and the second attachment portion comprises a magnetic element.

8. The movable attachment apparatus of claim 7, wherein an additional magnetic element is adhered to the back surface of the electronic portable device for attachment with the magnetic element of the second attachment portion.

9. The movable attachment apparatus of claim 1, wherein the back surface of the portable electronic device to which the first attachment portion is attached forms a portion of a detachable protective cover for the portable electronic device.

10. The movable attachment apparatus of claim 1, wherein the elongate body comprises one or more hinge elements between the first end and the second end.

11. A movable attachment apparatus, comprising:
a flexible elongate body;
a first attachment portion coupled on a first end to the flexible elongate body; and
a second attachment portion coupled on a second end to the flexible elongate body,
wherein the first attachment portion is attachable to a back surface of a portable electronic device at a first location, and
wherein the second attachment portion is attachable temporarily to the back surface of the portable electronic device at a second location that is different from the first location.
